(19) United States
(12) Patent Application Publication
(10) Pub. No.: US 2026/0145280 A1
(43) Pub. Date: May 28, 2026

(54) SYSTEMS, METHODS, AND APPARATUSES TO ASSIST IN LASER WELDING OPERATIONS

(71) Applicant: SF Motors, Inc., Milpitas, CA (US)

(72) Inventor: Nathan CHUNG, Milpitas, CA (US)

(73) Assignee: SF Motors, Inc., Milpitas, CA (US)

(21) Appl. No.: 18/962,752

(22) Filed: Nov. 27, 2024

(51) Int. Cl. B23K 37/04; B23K 26/066; B23K 26/70; B23K 101/38

(52) U.S. Cl. CPC B23K 37/04; B23K 26/066; B23K 26/702; B23K 2101/38

(57) ABSTRACT

Systems, methods, and apparatuses to assist a laser welding operation are provided. The system can include a base plate. The base plate can be coupled with a first end of a shaft. The system can include an end plate. The end plate can be coupled with a second end of the shaft. The system can include a spring. The spring can be coupled with the shaft. The spring can compress to a compressed position. The spring can compress to the compressed position responsive to movement of the block. The block can move toward the base plate with the end plate in a fixed position. The system can include a contactor. The contactor can be coupled with the block. The contactor can apply a force to a conductive element for laser welding with the spring in the compressed position.

### BACKGROUND

Conductive elements can contact one another and can carry an electrical current for various applications.

### SUMMARY

At least one aspect is directed to a system to assist a laser welding operation. The system can include a base plate. The base plate can be coupled with a first end of a shaft. The system can include an end plate. The end plate can be coupled with a second end of the shaft. The system can include a spring. The spring can be coupled with the shaft. The spring can compress to a compressed position. The spring can compress to the compressed position responsive to movement of the block. The block can move toward the base plate with the end plate in a fixed position. The system can include a contactor. The contactor can be coupled with the block. The contactor can apply a force to a conductive element for laser welding with the spring in the compressed position.

At least one aspect is directed to a method as part of a laser welding operation. The method can include coupling a base plate with a first end of a shaft. The method can include coupling an end plate with a second end of the shaft. The method can include coupling a block with the shaft. The block can be disposed between the base plate and the end plate. The block can be movable along the shaft. The method can include coupling a spring with the shaft. The spring can compress to a compressed position responsive to movement of the block. The block can move toward the base plate with the end plate in a fixed position. The method can include coupling a contactor with the block. The contactor can apply a force to a conductive element for laser welding with the spring in the compressed position.

At least one aspect is directed to an apparatus to assist a laser welding operation. The apparatus can include a base plate. The base plate can be coupled with a first end of a shaft. The apparatus can include an end plate. The end plate can be coupled with a second end of the shaft. The apparatus can include a spring. The spring can be coupled with the shaft. The spring can compress to a compressed position. The spring can compress to the compressed position responsive to movement of the block. The block can move toward the base plate with the end plate in a fixed position. The apparatus can include a contactor. The contactor can be coupled with the block. The contactor can apply a force to a conductive element for laser welding with the spring in the compressed position.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example system to assist a laser welding operation.

FIG. 2 depicts an example system to assist a laser welding operation.

FIG. 3 depicts an example apparatus to assist a laser welding operation.

FIG. 4 depicts an example apparatus to assist a laser welding operation.

FIG. 5 depicts an example apparatus to assist a laser welding operation.

FIG. 6 depicts an example apparatus to assist a laser welding operation.

FIG. 7 depicts an example apparatus to assist a laser welding operation.

FIG. 8 depicts an example method as part of a laser welding operation.

### DETAILED DESCRIPTION

Following below are more detailed descriptions of various concepts related to, and implementations of an apparatus for assisting in laser welding operations. The various concepts introduced above and discussed in greater detail below can be implemented in any of numerous ways.

Systems, methods, and apparatuses described herein relate to laser welding conductive elements. Various conductive elements can benefit from precise laser welding. As a part of laser welding operations, a steady and consistent force can be applied to a conductive element to bring it into contact with another conductive element, which can be prone to difficulties. For example, different compositions of conductive elements can have different tolerances for how much force can be applied before they are damaged. The positioning and spacing between the conductive elements can also result in challenges in how to reach the conductive elements to apply the force.

To resolve these and other challenges, systems, apparatuses, and methods for assisting in laser welding operations are described herein. The system can include a base plate couple with a first end of a shaft, an end plate coupled with a second end of the shaft, and a block coupled with the shaft, between the base plate and the end plate. The block can be movable along the shaft. For example, the block can slide vertically up and down the shaft. A spring can be coupled with the shaft, as the block moves toward the base plate, the spring can compress to the compressed position with the end plate remaining in a fixed position. A contactor can be coupled with the block to apply a force to a conductive element for laser welding with the spring in the compressed position.

The system can be modified or adjusted to allow for more specialized applications of force to the conductive element. For example, a precompression level of the spring can be modified by adding or removing shims to the system to increase or decrease the amount of force being applied to the conductive element, preventing damage from occur to the conductive elements during the laser welding operations.

The system can also be modified or adjusted to have the capabilities to reach conductive elements in unique positions. For example, the contactor can be switched out for contactors of various types. The different types of contactors can have different sized points of contact to apply the force to the conductive element. As well as various lengths and reaches.

As referred to herein, assisting in laser welding operations and to assist a laser welding operation can include structure and functionality to increase the efficiency of laser welding operations. As stated above the systems, methods, and apparatuses described herein can provide pressure to a wide variety of conductive elements in various positions by providing a system that can be customized for each unique laser welding setup. As a result, the system is more versatile in how it can be deployed, decreasing the need for a unique machine for each laser welding setup, and increasing the efficiency of the laser welding operations as a whole.

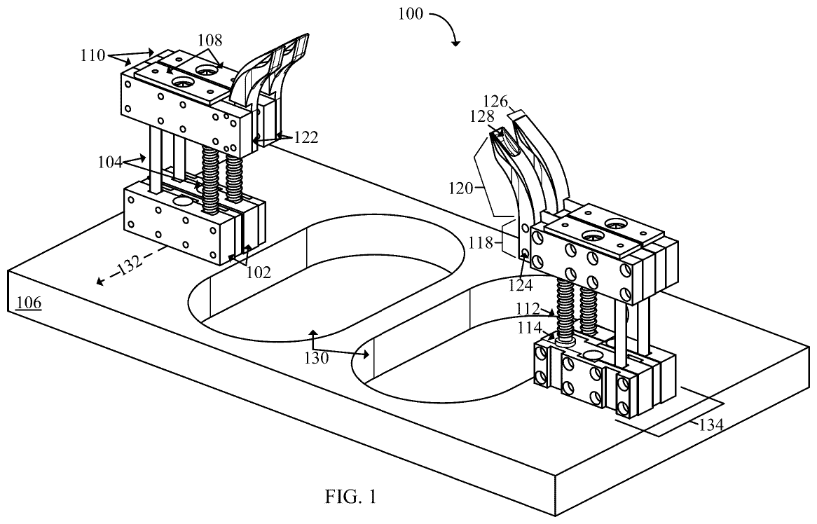

FIG. 1, among others, depicts an example of a system 100 to assist a laser welding operation. System 100 can include at least one base plate 102. Base plate 102 can be coupled with at least one shaft 104 and at least one mask plate 106. Base plate 102 can be removably coupled with shaft 104 or mask plate 106. For example, base plate 102 can be decoupled from mask plate 106 but remain coupled with shaft 104. Base plate 102 can be decoupled from shaft 104 but remain coupled with mask plate 106.

System 100 can include at least one shaft 104. Shaft 104 can be coupled with at least one base plate 102 and at least one end plate 108. Base plate 102 can be coupled with shaft 104 in a fixed position, such that base plate 102 cannot move along shaft 104. End plate 108 can be coupled with shaft 104 in a fixed position, such that end plate 108 cannot move along shaft 104.

Shaft 104 can be coupled with at least one block 110 such that shaft 104 traverses completely through block 110. Block 110 can be coupled with shaft 104 between base plate 102 and end plate 108. Block 110 can be moveable along shaft 104. For example, block 110 can slide along shaft 104. The movement of block 110 can be restricted by base plate 102 and end plate 108, preventing block 110 from moving past base plate 102 or end plate 108.

Shaft 104 can be coupled with at least one spring 112. Spring 112 can be wrapped around shaft 104. Spring 112 can be disposed along shaft 104 between base plate 102 and block 110. Spring 112 can include an element that holds a bias or compression force or that can impart a compression or other force on another element. Shaft 104 can be coupled with at least one shim 114. Shaft 104 can traverse completely through shim 114. Shim 114 can be disposed between spring 112 and base plate 102 or between spring 112 and block 110. Shaft 104 can be coupled with no shims 114. Shaft 104 can be independently decoupled from base plate 102, end plate 108, block 110, spring 112. For example, end plate 108, block 110, and spring 112 can be decoupled from shaft 104 while base plate 102 remains coupled with shaft 104.

Shaft 104 can include a first shaft 104 and a second shaft 104. First shaft 104 and second shaft 104 can both be coupled with the same base plate 102 and the same end plate 108. First shaft 104 or second shaft can be coupled with spring 112. For example, first shaft 104 can be coupled with a first spring 112 and second shaft 104 can be coupled with a second spring 112. First shaft 104 can be coupled with no spring 112 and second shaft 104 can be coupled with second spring 112.

First shaft 104 can be coupled with a first block 110 and second shaft 104 can be coupled with a second block 110. First block 110 can move along first shaft 104 independent of second block 110 and second block 110 can move along second shaft 104 independent of first block 110.

System 100 can include at least one end plate 108. End plate 108 can be coupled with at least one shaft 104. End plate 108 can be coupled with shaft 104 in a fixed position such that end plate 108 cannot move along shaft 104. End plate 108 can be removably coupled with shaft 104. End plate 108 can be coupled with a first shaft 104 and a second shaft 104.

End plate 108 can prevent block 110 from traversing along shaft 104 past end plate 108. For example, as block 110 moves away from base plate 102, it can come into contact with end plate 108. Preventing block 110 from moving any farther from base plate 102.

System 100 can include at least one block 110. Block 110 can be coupled with shaft 104. For example, block 110 can be disposed along shaft 104 between base plate 102 and end plate 108. Block 110 can be coupled with shaft 104 such that block 110 is movable along shaft 104. For example, block 110 can move along shaft 104 by sliding along the vertical dimension of shaft 104. Block 110 can be removably coupled from shaft 104. For example, block 110 can be decoupled from shaft 104 in response to end plate 108 being decoupled from shaft 104.

Block 110 can be in contact with spring 112. Block 110 moving toward base plate 102 can compress spring 112 to a compressed position. When block 110 is not moving along shaft 104, block 110 and spring 112 can remain in a neutral position.

Block 110 can be coupled with at least one contactor 116. For example, block 110 can be coupled with first end 118 of contactor 116 at connection point 122. Block 110 can include at least one fastening hole 124 to receive at least one fastener to couple block 110 with contactor 116. Block 110 can be coupled with a first contactor 116 and a second contactor 116. First contactor 116 can be on an opposite side of block 110 from second contactor 116. Block 110 can be in contact with at least one shim 114. For example, shim 114 may be disposed along shaft 104 between block 110 and spring 112.

Block 110 can be coupled with first shaft 104 and second shaft 104. For example, block 110 can simultaneously move across first shaft 104 and second shaft 104. Block 110 can include a first block 110 and a second block 110. First block 110 can be coupled with a first shaft 104 and second block 110 can be coupled with second shaft 104. First shaft 104 and second shaft 104 can be coupled with the same base plate 102. First shaft 104 can be coupled with a first base plate 102 and second shaft 104 can be coupled with a second base plate 102. For example, first block 110 can move along first shaft 104 independent from second block 110 moving along second shaft 104. First block 110 and second block 110 can move along first shaft 104 and second shaft 104 at the same time.

System 100 can include at least one spring 112. Spring 112 can be coupled with at least one shaft 104. For example, spring 112 can be wrapped around shaft 104. Spring 112 can be removably coupled with spring 112 to be switched out for a different spring 112. Spring 112 can be compressed to a compressed position and at rest in a neutral position. Spring 112 can be compressed to the compressed position responsive to block 110 moving toward base plate 102. Spring 112 can be at rest in the neutral position when block 110 is not moving. Spring 112 can be in contact with at least one shim 114. For example, at least one shim 114 can be disposed between spring 112 and base plate 102 or block 110.

Spring 112 can include a first spring 112 and a second spring 112. First spring 112 can be coupled with first shaft 104 and second spring 112 can be coupled with second shaft 104. First shaft 104 and second shaft 104 can be coupled with the same or different base plates 102. First spring 112 can compress to a first compressed position and second spring 112 can compress to a second compressed position. The second compressed position can be different from first compressed position. For example, the first compressed position can be compressed to a different length than second compressed position. First compressed position can have different tension than second compressed position.

The first spring 112 can be compressed to the first compressed position responsive to first block 110 moving toward base plate 102 at a first time. The second spring 112 can be compressed to the second compressed position responsive to second block 110 moving toward base plate 102 at a second time. The first time can be different from the second time. The first time can the same as the second time.

System 100 can include at least one contactor 116. Contactor 116 can be coupled with at least one block 110. Contactor 116 can be removably coupled with block 110. Contactor 116 can include at least one fastening hole 124. Fastening hole 124 can couple contactor 116 with block 110. Contactor 116 include at least one connection point 122 and at least one contact point 126. Connection point 122 can where contactor 116 couples with block 110. For example, connection point 122 can be where fastening holes 124 are located along contactor 116. Contactor 116 can come in contact or apply a pressure to at least one conducive element. For example, contact point 126 can apply a pressure to a conductive element to assist in a laser welding operation.

Contactor 116 can include a first end 118 and a second end 120. First end 118 and second end 120 can be disposed along opposite ends of contactor 116. For example, first end 118 can be disposed along contactor 116 closer to block 110 than second end 120. First end 118 can couple with block 110. First end 118 can include connection point 122 or fastening hole 124. Second end 120 can come in contact with the at least one conductive element and can include contact point 126.

First end 118 of contactor 116 can have a width or height between 2 mm and 15 mm (as well as widths or heights greater than or less than this range). Second end 120 of contactor 116 can also have a width or between 2 mm and 15 mm. The width or height of first end 118 can be different from the width or height of second end 120. For example, first end 118 can have a width of 8 mm and second end 120 can have a width of 5 mm. First end 118 can have a height of 4 mm and second end 120 can have a height of 10 mm. First end 118 and second end 120 can have the same width.

Contactor 116 can define an aperture 128. Aperture 128 can be disposed along the second end 120 of contactor 116. Aperture 128 can traverse through contactor 116. Aperture 128 can enable a beam of a laser welding apparatus to traverse through aperture 128 without damaging contactor 116.

A first type of contactor 116 can have a width or height between 0.05 mm and 9 mm, (as well as dimensions greater than or less than this range). A second type of contactor 116 can have a width between 10 mm and 19 mm. A third type of contactor 116 can define an aperture 128. A fourth type of contactor 116 can include first end 118 with a first width and second end 120 with a second width, where the second width is less than the first width. A fifth type of contactor 116 can include first end 118 with a first width and second end 120 with a second width, where the second width is greater than the first width. Any one of the contactors can have various heights or reaches (e.g., how far from block 110 contactor 116 reaches). For example, a first instance of the first type of contactor 116 can have a height of 3 inches and a second instance of the first type of contactor 116 can have a height of 5 inches. A first instance of the third type of contactor 116 can have a 1 inch reach, and a second instance of the third type of contactor 116 can have a 3 inch reach.

Contactor 116 can be moved to come into contact with the conductive element. Contactor 116 to be moved by at least one mask plate 106 being biased by at least one press plate. For example, a press plate can lower mask plate 106, and as a result contactor 116, toward the at least one conductive element. As the press plate lowers mask plate 106, contactor 116 can come in contact with at least one conductive element, applying a force to the conductive element. For example, contact point 126 can come in contact with at least one conductive element. Contactor 116 coming in contact with at least one conductive element can cause contactor 116 to apply a force to block 110 which can cause block 110 to move toward base plate 102, moving spring 112 to the compressed position.

Contactor 116 can include a first contactor 116 and a second contactor 116. The first contactor 116 and the second contactor 116 can be different types. First contactor 116 and second contactor 116 can be coupled with the same block 110. First contactor 116 can be coupled with a first block 110 and second contactor 116 can be coupled with a second block 110, where first block 110 is separate from second block 110. First block 110 can be coupled with a first shaft 104 and second block 110 can be coupled with a second shaft 104. First shaft 104 and second shaft 104 can be coupled with the same base plate 102. First shaft 104 can be coupled with a first base plate 102 and second shaft 104 can be coupled with a second base plate 102.

First contactor 116 can apply a first force to the conductive element. Second contactor 116 can apply a second force to the conductive element. First contactor 116 can apply first force to a first conductive element and second contactor 116 can apply second force to a second conductive element. The first force can be different from second force.

The first force and the second force can be applied at different times. For example, the first force can happen at a first time, and the second force can happen at a first time. The first force and the second force can be applied at different times due to them being applied by different contactors 116 coupled with different blocks 110. For example, first contactor 116 can be coupled with first block 110 and second contactor 116 can be coupled with second block 110. First block 110 and second block 110 can move independently from each other. This can be caused by first block 110 and second block 110 being coupled with different springs 112 coupled to the same base plate 102.

System 100 can include at least one mask plate 106. Mask plate 106 can include at least one opening 130. Opening 130 can traverse completely through mask plate 106. Opening 130 can allow a laser as part of the laser welding operation to pass through without damaging the rest of mask plate 106.

Mask plate 106 can be coupled with base plate 102 and at least one press plate. Base plate 102, end plate 108, and block 110 can be coupled with a first shaft 104 and a second shaft 104. Block 110 can be disposed between base plate 102 and end plate 108. Block 110 can be movable along first shaft 104 and second shaft 104. At least one spring 112 can be coupled with first shaft 104 or second shaft 104. For example, first shaft 104 can be coupled with spring 112 and second shaft 104 can have no spring 112. Second shaft 104 can be coupled with spring 112 and first shaft 104 can have no spring 112. First shaft 104 can be coupled with a first spring 112 and second shaft 104 can be coupled with a second spring 112. Spring 112 can compress to the compressed position responsive to movement of block 110 across first shaft 104 and second shaft 104 toward base plate 102 with end plate 108 in the fixed position. For example, first spring 112 and second spring 112 can compress to the same compressed position. Contactor 116 can be coupled with block 110 to apply a force to at least one conductive element for laser welding with first spring 112 and second spring 112 in the compressed position.

Mask plate 106 can be coupled with a first base plate 102 and a second base plate 102. Base plate 102 can be disposed along at least one axis 132 of mask plate 106. For example, first base plate 102 can be disposed along first axis 132 of mask plate 106 and second base plate 102 can be disposed along second axis 132 of mask plate 106. First axis 132 can be parallel or perpendicular to second axis 132.

First base plate 102 can be coupled with a first shaft 104. A first end plate 108 can be coupled with first shaft 104. A first block 110 can be coupled with first shaft 104, first block 110 can be disposed between first base plate 102 and first end plate 108. First block 110 can be movable along first shaft 104. A first spring 112 can be coupled with first shaft 104. First spring 112 can compress to a first compressed position responsive to movement of first block 110 toward first base plate 102 with first end plate 108 in a fixed position. A first contactor 116 can be coupled with first block 110 to apply a first force to the conductive element for laser welding with first spring 112 in the first compressed position.

Second base plate 102 can be coupled with second shaft 104. A second end plate 108 can be coupled with second shaft 104. A second block 110 can be coupled with second shaft 104, second block 110 can be disposed between second base plate 102 and second end plate 108. Second block 110 can be movable along second shaft 104. A second spring 112 can be coupled with second shaft 104. Second spring 112 can compress to a second compressed position responsive to movement of second block 110 toward second base plate 102 with second end plate 108 in a second fixed position. A second contactor 116 can be coupled with second block 110 to apply a second force to the conductive element for laser welding with second spring 112 in the second compressed position. The first force and the second force can be applied to the same conductive element. The first force and the second force can be applied to different conductive elements.

First base plate 102 and second base plate 102 can be disposed along axis 132 of mask plate 106. First base plate 102 can be not coupled with second base plate 102. For example, first base plate 102 can be coupled with shaft 104 and mask plate 106, second base plate 102 can be coupled with second shaft 104 and mask plate 106, with first base plate 102 not coupled with second base plate 102.

First contactor 116 and second contactor 116 can be different types. For example, first contactor 116 can define an aperture 128 and second contactor 116 can include no aperture 128. Second end 120 of first contactor 116 can have a width of 5 mm and second end 120 of second contactor 116 can have a width of 10 mm. First contactor 116 can have a different height from second contactor 116.

Mask plate 106 can have at least one plurality of base plates 102. For example, mask plate 106 can have a first plurality of base plates 102 arranged in a first row 134 on first axis 132 of mask plate 106. First plurality of base plates 102 can include first base plate 102. Mask plate 106 can also have a second plurality of base plates 102 arranged in a second row 134 on a second axis 132 of mask plate 106. Second plurality of base plates 102 not including first base plate 102. First axis 132 can be parallel to second axis 132. First axis 132 can be perpendicular to second axis 132.

At least one opening 130 can be disposed between first axis 132 and the second axis 132. For example, mask plate 106 can have a first opening 130 and a second opening 130 disposed between the first base plate 102 and the second base plate 102. Mask plate 106 can have at least one opening 130 disposed between first row 134 and second row 134.

A contactor 116 of base plate 102 can extend away from block 110 coupled with contactor 116, such that at second end 120 of contactor 116 extends over opening 130 of mask plate 106. As a result, a laser of a laser welding operation can traverse through aperture 128 and opening 130, without damaging mask plate 106 or contactor 116.

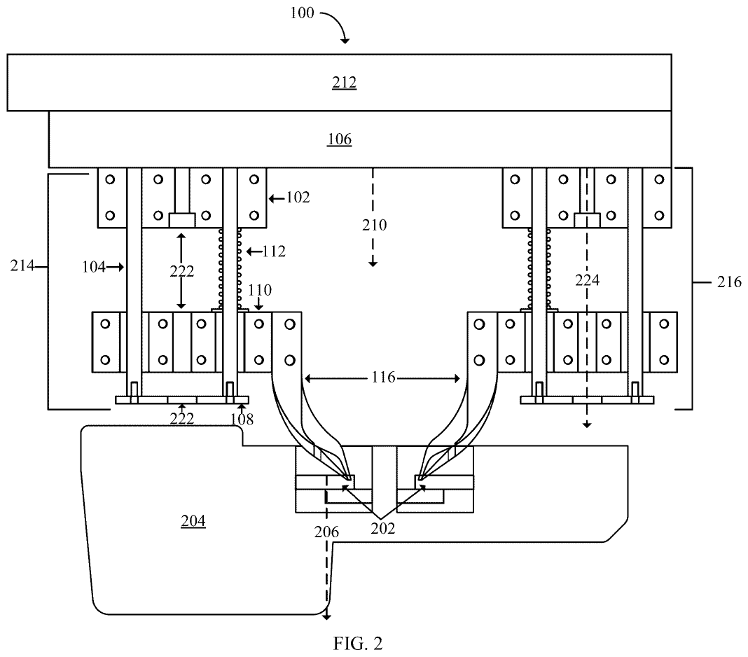

FIG. 2, among others, depicts an example of system 100 to assist the laser welding operation. System 100 can include at least one conductive element 202. Conductive element 202 can be made of an electrically conductive material, such as a metal. For example, conductive element 202 can be made of copper. Conductive element 202 can be a part of an electrical system 204. For example, electrical system 204 can be a battery, solar panels, power electronics such as semiconductors, electric vehicle, or another larger electrical system. Conductive element 202 can be a bus bar of a battery, a lead frame of a semi-conductor switching device, a terminal of a batter, or another input or output of an electrical component. Conductive element 202 can include a bus bar of an inverter for an electric vehicle.

Conductive element 202 can include a first conductive element 202 and a second conductive element 202. First conductive element 202 and second conductive element 202 can be disposed in the same or different electrical system 204. First conductive element 202 can be parallel with second conductive element 202. First conductive element 202 and second conductive element 202 can be aligned on at least one vertical axis 206 such that first conductive element can be disposed above second conductive element 202. There can be an air gap between first conductive element 202 and second conductive element 202. To allow an electrical current to flow from first conductive element 202 to second conductive element 202, or from second conductive element 202 to first conductive element 202, the air gap between the two conductive elements can be eliminated by performing a laser welding operation to get first conductive element to come in contact with second conductive element.

The laser welding operation can include a force being applied to one of the conductive elements 202 by contactor 116. The force being applied to first conductive element 202 can result in an edge or face of first conductive element 202 coming in contact with second conductive element 202. The force may then keep first conductive element 202 in contact with second conductive element 202 to enable a laser of the laser welding operation to weld the first conductive element 202 with the second conductive element 202.

The system 100 can include at least one press plate 212. Press plate 212 can traverse along at least one set axis 210. For example, the press plate 212 can lower along set axis 210. Press plate 212 can be coupled with at least one mask plate 106. Press plate 212 traversing along set axis 210 can bias mask plate 106. For example, press plate 212 lowering along the set axis 210 can result in mask plate 106 also being lowered along set axis 210. Press plate 212 biasing mask plate 106 can move contactor 116 to come in contact with conductive element 202.

For example, press plate 212 can bias mask plate 106 toward conductive element 202. Press plate 212, as a result of biasing mask plate 106, brings contactor 116 in contact with conductive element 202. As press plate 212 continues to lower toward conductive element 202, block 110 can compress spring 112 from a neutral position 214 to a compressed position 216. Once in compressed position 216 first conductive element 202 can be in contact with second conductive element 202. The laser welding operation can then transmit a laser to contact the first conductive element 202 or second conductive element 202. Resulting in first conductive element 202 to be coupled with second conductive element 202 allowing an electric current to flow between first conductive element 202 and second conductive element 202.

Press plate 212 can bring a first contactor 116 in contact with a first conductive element 202 and a second contactor 116 in contact with a second conductive element 202. Press plate 212 can bring a first contactor 116 and second contactor 116 in contact with the same conductive element 202.

End plate 108 can have a first fastening hole 222, block 110 can have a second fastening hole 222, and base plate 102 can have a third fastening hole 222. First fastening hole 222, second fastening hole 222, and third fastening hole 222 can be disposed along a first axis 224. A fastener (e.g., a screw, a nut and bolt, etc.) and a fastening tool (e.g., a screwdriver, a wrench, etc.) can be inserted through fastening holes 222 to couple base plate 102 with mask plate 106. The fastening tool can then be re inserted through fastening holes 222 to decouple base plate with mask plate 106.

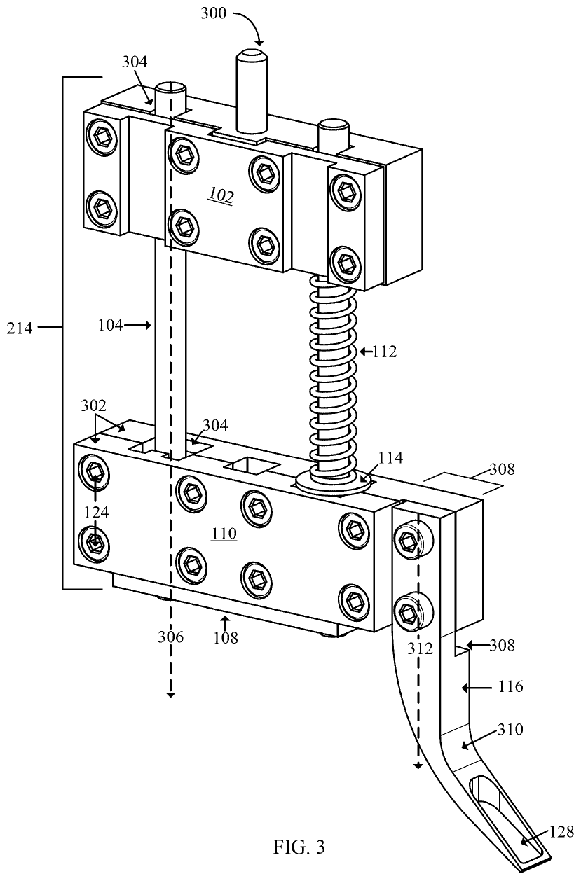

FIG. 3, among others, depicts an example of apparatus 300 to assist the laser welding operation. Base plate 102, block 110, and end plate 108 can be a variety of shapes. For example, Base plate 102, block 110, or end plate 108 can be a regular polyhedral solid (e.g., a cube, a tetrahedron, etc.) including one or more flat polygonal faces, straight edges, and vertices. Base plate 102, block 110, and end plate 108 can be an irregular polyhedral solid including one or more faces of a first shape and one or more faces of a second shape, such as an irregular pyramid with one or more faces that are triangular and one or more faces that are rectangular. Base plate 102, block 110, and end plate 108 can be a non-polyhedral solid (e.g., a sphere, an ellipsoid, a cylinder, etc.) including one or more curved surfacers or edges. For example, base plate 102 can be a cylinder, block 110 can be a rectangular prism, and end plate 108 can be a cube.

Base plate 102, block 110, and end plate 108 can include one or more materials. The one or more materials can include various metals (e.g., aluminum, alloy steel, tin, etc.), non-metals, woods, polymers, or the like. For example, base plate 102 can be made of wood, block 110 can be made of a plastic, and end plate 108 can be made of aluminum. Base plate 102, block 110, and end plate 108 can include one or more parts coupled with each other. For example, base plate 102 can include at least one part 302. Part 302 can include a first part 302 coupled with a second part 302. Base plate 102, block 110, and end plate 108 can include one or more fastening holes 124. Parts 302 can be coupled with each other through one or more fastening holes 124 and one or more fasteners (e.g., screws, nails, dowels, etc.), one or more joints (e.g., miter joint, dovetail joint, etc.), an adhesive (e.g., epoxy, glue, acrylic, etc.), welded together, or the like. Parts 302 can include a combination of a shapes or materials. For example, first part 302 can be a wooden cube while second part 302 can be polymer based irregular polyhedral solids.

Base plate 102, block 110, and end plate 108 can include at least one opening 304 to receive shaft 104. Opening 304 can be disposed along any face of base plate 102, block 110, and end plate 108 and can completely traverse through the interior of base plate 102, block 110, and end plate 108 to exit along a second face. For example, opening 304 can be disposed along a first face of base plate 102 and then exit along a second face of base plate 102, the second face opposite the first face. Opening 304 can have a variety of cross-sectional areas. For example, opening 304 can have a rectangular, square, circular, oval, or an irregular shaped cross-sectional area.

Opening 304 of base plate 102, block 110, and end plate 108 can be disposed along at least one vertical axis 306. Openings 304 disposed along vertical axis 306 can have varying cross-sectional areas. For example, a first opening 304 of base plate 102 on vertical axis 306 can have a circular cross-sectional area, a second opening 304 of block 110 on vertical axis 306 can have a square cross-sectional area, and a third opening 304 of end plate 108 can have an irregular shaped cross-sectional area.

Base plate 102, block 110, and end plate 108 can include a first opening 304 and a second opening 304 to receive first shaft 104 and second shaft 104. First opening 304 and second opening 304 can be disposed along a single face of base plate 102, block 110, or end plate 108. First opening 304 can be parallel to second opening 304. First opening 304 can have a different cross-sectional area than second opening 304. For example, first opening 304 can have a circular cross-sectional area and

Shaft 104 can be a variety of shapes. For example, shaft 104 can be a cylinder or a rectangular prism. Shaft 104 can have a cross-sectional area in the shape of a rectangle, square, circle, or oval. Shaft 104 can be a metal or non-metal material. Shaft 104 can have a greater vertical dimension than a horizontal dimension (e.g., having a height greater than the width).

Shaft 104 can be coupled with base plate 102 or end plate 108 such that shaft 104 ends within base plate 102. For example, shaft 104 may enter a first face of base plate 102, and then end within base plate 102. Shaft 104 can be coupled with base plate 102 or end plate 108 such that shaft 104 traverses through base plate 102 or end plate 108 and ends outside of base plate 102 or end plate 108. For example, shaft 104 may enter a first face of base plate 102, exit a second face opposite the first face, and then end thereafter.

First shaft 104 and a second shaft 104. can be made of the same material or different materials. For example, first shaft 104 can be made of aluminum and second shaft 104 can be made of plastic. First shaft 104 and second shaft 104 can have different shapes. For example, first shaft 104 can be a cylinder and second shaft 104 can be a rectangular prism. First shaft 104 and second shaft 104 can have different cross-sectional areas. For example, first shaft 104 can have a circular cross-sectional area and second shaft 104 can have an oval cross-sectional area. First shaft 104 and second shaft 104 can have different heights or widths. For example, first shaft 104 can have a height and width greater than the height and width of second shaft 104.

Spring 112 can be a compression, tension, torsion, or another type of spring. Spring 112 can be a helical spring, leaf spring, torsion spring, or the like. For example, spring 112 can be a stainless steel helical compression spring. Spring 112 can be a metal or nonmetal helical spring, cylindrical spring, conical spring, barrel spring, or the like. Spring 112 can have a length less than or equal to the length of shaft 104. Spring 112 can have a variety of characteristics such as a stiffness, a working stroke, and a precompression level. The precompression level can be tuned to ensure a specific pressure is applied to conductive element 202 by contactor 116 when spring 112 is in compressed position 216. The precompression level can be tuned by switching spring 112 for a different spring 112 or by adding or removing shims 114. The precompression level can increase the tension of spring 112 in compressed position 216 and neutral position 214. The precompression level can vary across springs 112. For example, first spring 112 can have a first precompression level and second spring 112 can have a second precompression level. The various precompression levels can result in first spring 112 having a first compressed position 216 and second spring 112 having a second compressed position. Where the tension in first spring 112 is different from the tension in second spring 112 due to the difference in precompression levels.

Spring 112 can have a different length in compressed position 216 than neutral position 214. For example, spring 112 can have a length of 25 mm to 75 mm in neutral position 214 and a length of 5 mm to 25 mm in compressed position 216.

Shim 114 can be a piece of metal or non-metal disposed along shaft 104. For example, shim 114 can include a washer such as a steel, metal, non-metal, or iron washer. Shim 114 can increase the precompression level of spring 112 by shortening the working stroke of spring 112. Shim 114 can include a plurality of shims 114 stacked on top of one another along shaft 104. The number of shims 114 can be directly proportional to the precompression level of spring 112. For example, the more shims 114, the greater the precompression level, the less shims 114, the lesser the precompression level.

Block 110 can include at least one lip 308. Lip 308 can include a first width less than the width of the rest of block 110. Lip 308 can include at least one fastening hole 124. Lip 308 can be the part of block 110 to couple with contactor 116.

Contactor 116 can be made of one or more materials. The one or more materials can include various metals (e.g., aluminum, alloy steel, tin, etc.), non-metals, woods, polymers, or the like. Contactor 116 can also include one or more parts coupled with each other, each part being coupled together through one or more methods (e.g., one or more fastening holes and fasteners, one or more joints, an adhesive, etc.) and each part can be a variety of shapes (e.g., a regular polyhedral solid, an irregular polyhedral solid, a non-polyhedral solid, etc.).

Contactor 116 can include at least one lip 308. Lip 308 of contactor 116 can be coupled with lip 308 of block 110. First end 118 can include lip 308. Connection point 122 can include lip 308.

Aperture 128 of contactor 116 can have a polygonal or non-polygonal cross-sectional area. For example, aperture 128 can have a circular cross-sectional area. The cross-sectional area of aperture 128 can vary throughout aperture 128. For example, aperture 128 can begin on a top surface of contactor 116 with a first cross-section area, then gradually increase to a second cross-section area along the bottom surface of contactor 116. Aperture 128 can have one or more edges that can be straight or curved. For example, aperture 128 can have a curved edge and a straight edge, the curved edge opposite the straight edge.

Contactor 116 can extend away from block 110, connection point 122, fastening hole 124. For example, contactor 116 can extend vertically away from block 110 along at least one contactor axis 312. Contactor 116 can include at least one curved surface 310. For example, as contactor 116 extends vertically away from block 110 along contactor axis 312, curved surface 310 can curve horizontally away from contactor axis 312. Resulting in contactor 116 having a crescent or c-shaped appearance.

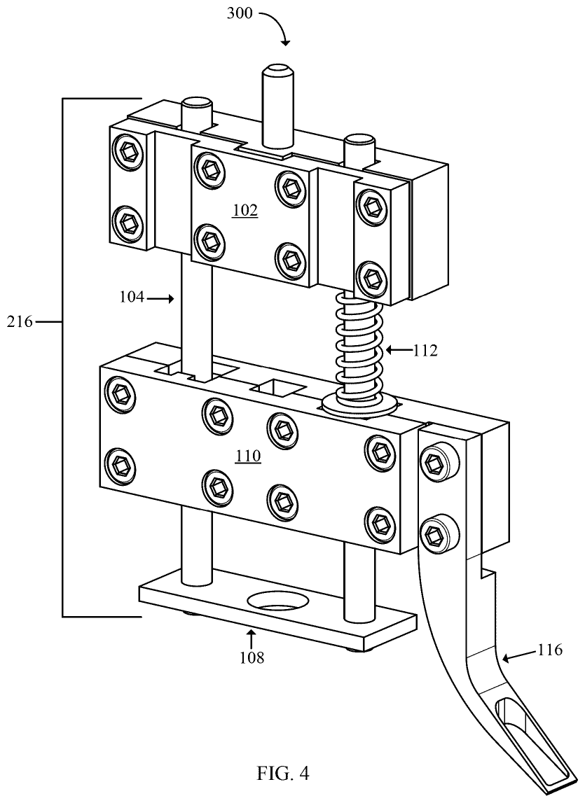

FIG. 4, among others, depicts an example of apparatus 300 to assist the laser welding operation. Apparatus 300 can include spring 112 in compressed position 216. Spring 112 can be compressed to compressed position 216 responsive to movement of block 110 along shaft 104 toward base plate 102 with end plate 108 in a fixed position. Block 110 can move toward base plate 102 responsive to contactor 116 coming in contact with conductive element 202. Contactor 116 can come in contact with conductive element 202 responsive to press plate 212 biasing mask plate 106 toward conductive element 202.

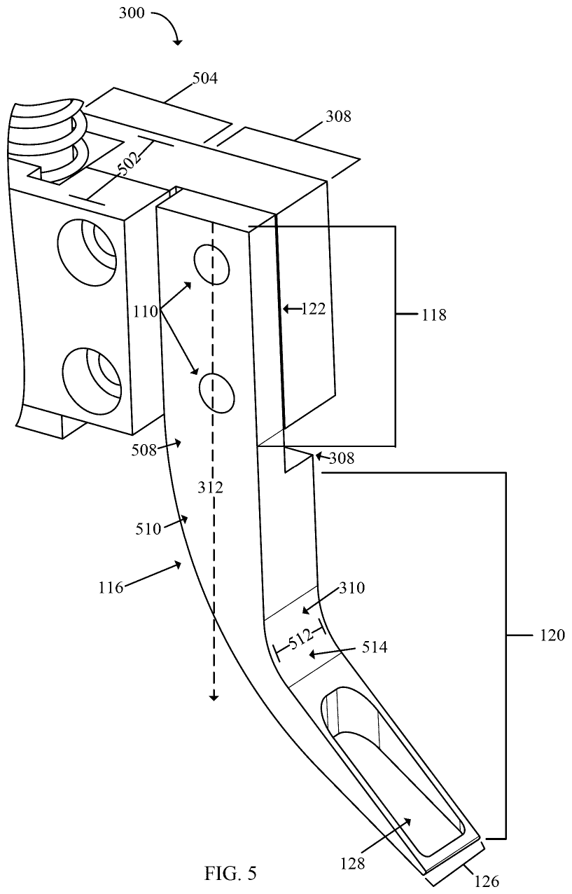

FIG. 5, among others, depicts the apparatus 300 to assist a laser welding operation. Block 110 can include at least one width 502. Block 110 can include at least one lip 308 and at least one body 504. Body 504 can have a first width 502 and lip 308 can have a second with 502, first width 502 less than second width 502. For example, first width 502 can be half of the second width 502. Block 110 can, at least partially, take the shape of a step, which can include body 504 stepping down to lip 308 or first width 502 stepping down to the second width 502.

Lip 308 can include at least one fastening hole 124 to couple block 110 with contactor 116. For example, the lip 308 can have a first fastening hole 124 and a second fastening hole 124 disposed along at least one contactor axis 312 of at least one face 508 of contactor 116.

Apparatus 300 can include at least one contactor 116. Contactor 116 can include at least one face 508. For example, contactor 116 can include first face 508, a second face 508, a third face 508, and fourth face 508. First face 508 can be opposite third face 508 and second face 508 can be opposite fourth face 508. First face 508 and third face 508 can be perpendicular with second face 508 and fourth face 508. Faces 508 can have at least one width 512. Width 512 can vary across faces 508. For example, first face 508 can have a first width 512, second face 508 can have a second width 512, third face 508 can have a third width 512, and fourth face 508 can have a fourth width 512. Any combination of first width 512, second width 512, third width 512, and fourth width 512 can be equal to one another. For example, first width 512 and second width 512 can both be 5 mm.

Contactor 116 can include at least one edge 510. For example, contactor 116 can include first edge 510, second edge 510, third edge 510, and fourth edge 510. First edge 510 can be a shared edge of first face 508 and second face 508. Second edge 510 can be a shared edge of second face 508 and third face 508. Third edge 510 can be a shared edge of third face 508 and fourth face 508. Fourth edge can be a shared edge of fourth face 508 and first face 508.

Faces 508 and edges 510 can begin at lip 308. Lip 308 can be disposed on first end 118 of contactor 116. Lip can be defined by faces 508 and edges 510. Lip 308 can include fastening holes 124 disposed on face 508 along contactor axis 312. Lip 308 can couple with lip 308 of block 110. Connection point 122 can be disposed along lip 308 and at least one face 508.

Faces 508 and edges 510 can continue to extend past lip 308 along first end 118. As faces 508 extend past lip 308, widths 512 can vary. For example, the width of second face 508 and fourth face 508 can double in width.

As faces 508 and edges 510 continue to extend along contactor axis 312, from first end 118 toward second end 120, faces 508 can curve into a curved surface 310 and edges can curve into curved edges 514. For example, edges 510 can curve away from contactor axis 312 to form curved edges 514. First face 508 and third face 508 can curve away from contactor axis 312 to form a first curved surface 310 and a second curved surface 310. Second face 508 and fourth face 508 can curve toward block 110.

Faces 508 and edges 510 can continue to extend into second end 120 toward contact point 126. As faces 508 continue to along contactor 116 toward contact point 126, widths 512 can vary. For example, first face 508 and second face 508 can start with a first width 512 at lip 308 and then gradually tapper to a second width 512 near contact point 126.

Contact point 126 can be a single edge 510 shared by faces 508. For example, the width 512 of first face 508 and third face 508 can continuously decrease until second face 508 and fourth face 508 meet at contact point 126. Contact point 126 can be the part of contactor 116 to apply pressure to conductive element 202 during the laser welding operation. Contact point 126 can be a curved or straight edge that can apply a constant pressure to conductive element 202 to ensure efficient welding of conductive element 202.

Second face 508 and fourth face 508 can define aperture 128. Aperture 128 can be defined along second end 120 of contactor 116. Aperture 128 can define less than or equal to half the surface area of second face 508 and fourth face 508. Aperture 128 can share first edge 510 with first face 508 and second edge 510 with third face 508. Aperture 128 can end at contact point 126. Aperture 128 can include one or more curved or straight edges 510. For example, aperture 128 can include a curved edge 510 opposite a straight edge 510. Contactor 116 can have no aperture 128.

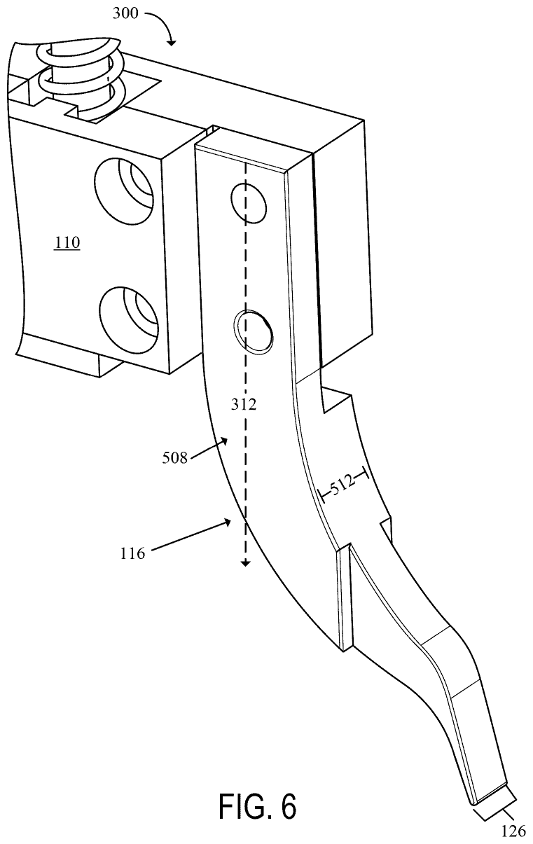

FIG. 6, among others, depicts the apparatus 300 to assist a laser welding operation. Width 512 can be between 0.05 mm and 20 mm. Width 512 of faces 508 can vary throughout contactor 116. For example, faces 508 along first end 118 can have a width of 15 mm and then gradually decrease to 10 mm near contact point 126. Faces 508 along first end 118 can have a width 512 of 2 mm and then gradually increase to a width 512 of 5 mm.

First face 508 and third face 508 can first curve away from contactor axis 312 and then curve back toward contactor axis 312. Second face 508 and fourth face 508 can first curve toward block 110 and then curve away from block 110.

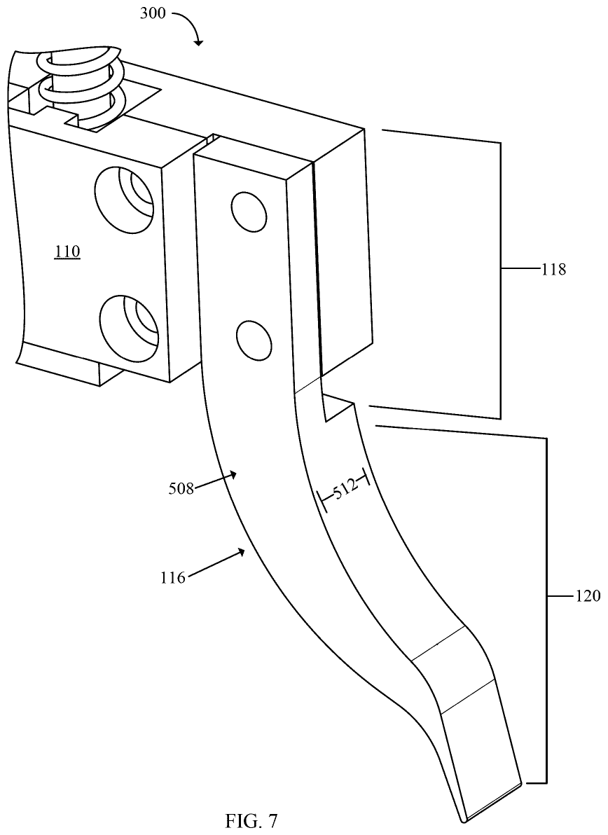

FIG. 7, among others, depicts the apparatus 300 to assist a laser welding operation. Width 512 of faces 508 can remain constant across contactor 116. For example, width 512 can remain constant across second end 120 of contactor 116.

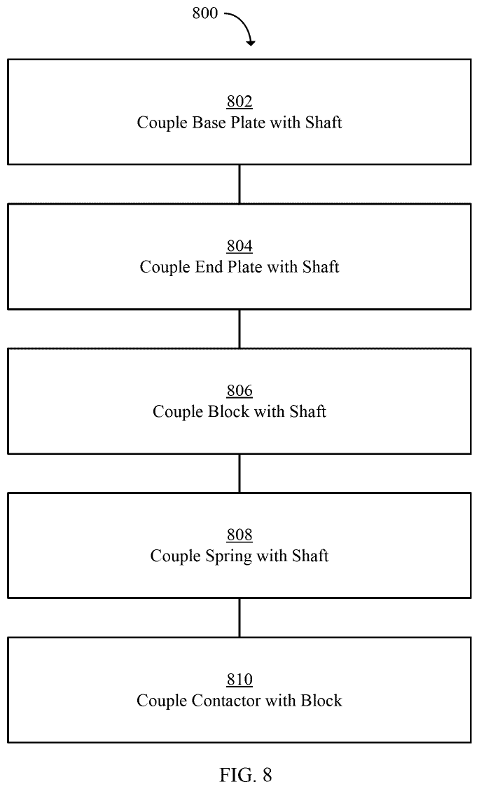

FIG. 8, among others, depicts a method 800 as part of a laser welding operation. Method 800 can include at least one act of coupling base plate 102 shaft 104 (e.g., act 802). For example, base plate 102 can be coupled with first end 118 of shaft 104. Base plate 102 can be coupled with shaft 104 using a keyed coupling, one or more screws, a sleeve, or the like.

Method 800 can include at least one act of coupling end plate 108 with shaft 104 (e.g., act 804). For example, end plate 108 can be coupled with a second end 120 of shaft 104. End plate 108 can be coupled with shaft 104 using can be coupled with shaft 104 using a keyed coupling, one or more screws, a sleeve, or the like.

Method 800 can include at least one act of coupling block 110 with shaft 104 (e.g., act 806). For example, block 110 can be coupled with shaft 104, disposed between base plate 102 and end plate 108, such that block 110 can move along shaft 104.

Method 800 can include at least one act of coupling spring 112 with shaft 104 (e.g., act 808). For example, spring 112 can couple with shaft 104 such that spring 112 can compress to compressed position 216 responsive to movement of block 110 toward base plate 102. End plate 108 can remain in a fixed position while block 110 moves along shaft 104. Spring 112 can be coupled with shaft 104 by wrapping spring 112 around shaft 104.

Method 800 can include at least one act of coupling contactor 116 with block 110 (e.g., act 810). Contactor 116 can be coupled with block 110 using fastening holes 124 and one or more fasteners. Contactor 116 can couple with block 110 to enable contactor 116 to apply a force to conductive element 202 for laser welding. Responsive to applying the force to conductive element 202, block 110 may move spring 112 to compressed position 216.

End plate 108 can include a first fastening hole 124. First fastening hole 124 can be on axis 224 traversing end plate 108. Block 110 can include a second fastening hole 124. Second fastening hole 124 can be on axis 224 traversing block 110. Base plate 102 can include a third fastening hole 124. Third fastening hole 124 can be on axis 224 traversing base plate 102.

First fastening hole 124, second fastening hole 124, and third fastening hole 124 can all be disposed on axis 224 traversing through end plate 108, block 110, and base plate 102. First fastening hole 124 can include a first diameter, second fastening hole 124 can include a second diameter, and third fastening hole can include a third diameter. One or more of the first diameter, the second diameter, or the third diameter can be equal to another. One or more of the first diameter, the second diameter, or the third diameter can be greater than or less than each other. The diameter, the second diameter, and the third diameter can be sized to allow a fastener and a tool for the fastener to be inserted through the series of fastening holes 124.

Method 800 can include at least inserting a fastener through first fastening hole 124, second fastening hole 124, and third fastening hole 124 to couple base plate 102 to mask plate 106. The fastener can include a screw, a nail, a nut or bold, or another fastener adequate for coupling or decoupling base plate 102 with mask plate 106. For example, a screw and a screwdriver can be inserted through first fastening hole 124, second fastening hole 124, and third fastening hole 124 to couple base plate 102 with mask plate 106. Then, the screwdriver can be inserted through first fastening hole 124, second fastening hole 124, and third fastening hole 124 to remove the screw. Decoupling base plate 102 with mask plate 106.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system to assist a laser welding operation, comprising:
a base plate coupled with a first end of a shaft;
an end plate coupled with a second end of the shaft;
a block coupled with the shaft, the block disposed between the base plate and the end plate, the block movable along the shaft;
a spring coupled with the shaft, the spring to compress to a compressed position responsive to movement of the block toward the base plate with the end plate in a fixed position; and
a contactor coupled with the block to apply a force to a conductive element for laser welding with the spring in the compressed position.

2. The system of claim 1, comprising:
a mask plate to couple with the base plate; and
a press plate to bias the mask plate to move the contactor into contact with the conductive element.

3. The system of claim 1, comprising:
a second base plate coupled with a first end of a second shaft;
a second end plate coupled with a second end of the second shaft;
a second block coupled with the second shaft, the second block disposed between the second base plate and the second end plate, the second block movable along the shaft;
a second spring coupled with the second shaft, the second spring to compress to a second compressed position responsive to movement of the second block toward the second base plate; and
a second contactor coupled with the second block to apply a second force to the conductive element.

4. The system of claim 1, wherein the compressed position is a first compressed position, comprising:
a second spring coupled with a second shaft, the second spring to compress to a second compressed position responsive to movement of a second block, the second compressed position different than the first compressed position.

5. The system of claim 1, wherein the force is a first force, comprising:
a second contactor coupled with a second block to apply a second force to the conductive element, the second force different than the first force.

6. The system of claim 1, wherein the conductive element is a first conductive element, comprising:
a second contactor coupled with a second block to apply a second force to a second conductive element.

7. The system of claim 1, wherein the contactor is a first contactor, comprising:
a second contactor, wherein the second contactor is a different type of contactor than the first contactor.

8. The system of claim 1, wherein the base plate is a first base plate, comprising:
a second base plate coupled with a mask plate, the second base plate not coupled with the first base plate.

9. The system of claim 1, comprising:
the contactor coupled with the block to apply the force to the conductive element, wherein the conductive element includes a bus bar of an inverter.

10. The system of claim 1, comprising:
the contactor including a fastening hole to fasten the contactor to the block at a connection point; and
the contactor extending from the connection point to a contact point, the contactor having a curved surface, the contact point to apply the force to the conductive element as part of the laser welding operation.

11. The system of claim 1, comprising:
the contactor including a first end coupled with the block; and
the contactor including a second end to contact the conductive element, the first end having a width greater than a width of the second end.

12. The system of claim 1, comprising:
the contactor including a first end coupled with the block; and
the contactor including a second end to contact the conductive element, the second end having a width between 2 mm to 15 mm.

13. The system of claim 1, comprising:
the contactor configured to define an aperture, the aperture configured to allow a laser to pass through the aperture as part of the laser welding operation.

14. The system of claim 1, comprising:
a shim coupled with the shaft, the shim disposed between the spring and the block.

15. The system of claim 1, wherein the base plate is a first base plate, comprising:
a mask plate;
a first plurality of base plates including the first base plate arranged in a first row on a first axis of the mask plate;
a second plurality of base plates not including the first base plate, the second plurality of base plates arranged in a second row on a second axis of the mask plate; and
the mask plate defining an aperture between the first row and the second row.

16. The system of claim 1, comprising:
a second shaft;
a first end of the second shaft coupled with the base plate;
a second end of the second shaft coupled with the end plate; and
the block coupled with the second shaft, the block movable along the second shaft.

17. The system of claim 1, comprising:
a first fastening hole on a first axis traversing the end plate;
a second fastening hole on the first axis traversing the block; and
a third fastening hole on the first axis traversing the base plate, each of the first fastening hole, the second fastening hole, and the third fastening hole configured to receive a fastener to couple the base plate with a mask plate.

18. A method as part of a laser welding operation, comprising:
coupling a base plate with a first end of a shaft;
coupling an end plate with a second end of the shaft;
coupling a block with the shaft, the block disposed between the base plate and the end plate, the block movable along the shaft;
coupling a spring with the shaft, the spring to compress to a compressed position responsive to movement of the block toward the base plate with the end plate in a fixed position; and
coupling a contactor with the block to apply a force to a conductive element for laser welding with the spring in the compressed position.

19. The method of claim 18, comprising:
a first fastening hole on a first axis traversing the end plate;
a second fastening hole on the first axis traversing the block;
a third fastening hole on the first axis traversing the base plate; and
inserting a fastener through the first fastening hole, the second fastening hole, and the third fastening hole to couple the base plate to a mask plate.

20. An apparatus to assist a laser welding operation, comprising:
a base plate coupled with a first end of a shaft;
an end plate coupled with a second end of the shaft;
a block coupled with the shaft, the block disposed between the base plate and the end plate, the block movable along the shaft;
a spring coupled with the shaft, the spring to compress to a compressed position responsive to movement of the block toward the base plate with the end plate in a fixed position; and
a contactor coupled with the block to apply a force to a conductive element for laser welding with the spring in the compressed position.
